(19) United States
(12) Patent Application Publication
(10) Pub. No.: US 2019/0250781 A1
(43) Pub. Date: Aug. 15, 2019

(54) Smart Mirror System

(71) Applicant: Alexander Savitski, Arlington Heights, IL (US)

(72) Inventor: Alexander Savitski, Arlington Heights, IL (US)

(21) Appl. No.: 15/897,558

(22) Filed: Feb. 15, 2018

(51) Int. Cl. G06F 3/0484; H04M 1/725; H04M 1/02; H04L 12/28

(52) U.S. Cl. CPC G06F 3/0484; H04M 1/72552; G06F 3/167; H04M 1/0264; H04L 12/282; H04M 1/72569

(57) ABSTRACT

A device comprising a reflective mirror surface including a front face, a camera oriented to capture image of user, a processor in communication with the camera to receive image data captured by the camera, an electronic display in communication with the processor through which the processor provides a GUI visible at the face of the mirror, an input mechanism other than a touchscreen input mechanism, the input mechanism providing input data from a user to the processor, and a memory in communication with the processor, the memory storing a plurality of personalized user settings associated with image data and executable instructions that, when executed by the processor, cause the processor to receive image data from the camera, recognize a user based on image data received from the camera, adapt one or more settings of the GUI in response to recognizing the user based on image data received from the camera.

### BACKGROUND OF THE INVENTION

The present invention relates to a smart mirror. More specifically, the present invention relates to an internet connected smart mirror system featuring a graphical user interface.

Almost every human dwelling in modern society features at least one mirror in which people can assess their appearance. Mirrors are so invaluable to humans that obsidian mirrors have been found which date back to roughly 6000 B.C. The modern, mass production techniques for creating mirrors began around 200 years ago, with the mirrors primary function: to reflect images, remaining essentially unchanged for most of human history.

However, mirrors, even in their modern forms, are not without shortcomings. Likely the biggest issue with any mirror is that it has a single function which it performs well (reflecting images) but is not capable of carrying out any other tasks. This becomes an issue with modern mirrors in particular as many of them are large in size and take up the majority of a bathroom or bed room wall. Many people live in smaller apartments, condos, dorm rooms, etc. and thus where ever space is at a premium, mirrors take up a good deal of space which could be utilized for storage, etc.

Modern technology is positioned to address the limited functionality of mirrors but no one, as of yet, has added functionality to mirrors in a meaningful way. Some solutions change the color of a mirror and others integrate the basic display of information, but none offer an easy to use graphical user interface nor offer integration with other smart home technology which enables people stay connected while consuming and exchanging information.

Accordingly, there is a need for an internet connected smart mirror system featuring a graphical user interface.

### BRIEF SUMMARY OF THE INVENTION

To meet the needs described above and others, the present disclosure describes a smart mirror system featuring a graphical user interface.

In one embodiment, the system may feature a smart mirror which can function as a standard mirror in the bathroom, bed room, living room and also have the ability to act as a digital display. When activated, the smart mirror will display a graphical user interface featuring any number of computer applications, news updates, weather, as well as text messages, SMS messages, and social media posts. To enable this display of information, the smart mirror may be connected to a centralized server which communicates with the mirror over the Internet or another means of data communication. This centralized system may store user profiles and settings as well as communicate with external data sources and other end user devices to enable the smart mirror system to control other smart home devices, etc.

The graphical user interface displayed by the system may be activated by voice control, hand gesture, smartphone gesture, or even activated remotely via another end user device (e.g., another smart home device). Activation via voice, gesture, etc. is important because touching mirrors dirties them and, particularly in the bathroom, wet hands can damage the mirror or prevent a touchscreen from working properly. The present system may store a profile for each user and each of these profiles may have a unique voice or gesture tied to the profile to enable the system to display the correct set of applications, text messages, etc. to each end user. Once activated, the end user may then continue to control the mirror via voice, gestures, etc.

Various embodiments of the present invention may also include the following components: a touch screen interface; touch screen controller chip; microprocessor (CPU); batteries; graphics processors (GPU); flash-based memory; Wi-Fi and/or cellular communication microchips and antennas; USB and/or Lightning connector dock(s); a power supply; internal or external speakers; camera sensors, controllers and lenses; and a Bluetooth or other personal area network receiver.

One embodiment of the present invention may be described as a device comprising a reflective mirror surface including a front face; a camera oriented to capture image of user located in position in front of the reflective mirror surface; a processor in communication with the camera to receive image data captured by the camera; an electronic display in communication with the processor through which the processor provides a GUI visible at the front face of the mirror; an input mechanism other than a touchscreen input mechanism, the input mechanism providing input data from a user to the processor; and a memory in communication with the processor, the memory storing a plurality of personalized user settings associated with image data and executable instructions that, when executed by the processor, cause the processor to receive image data from the camera; recognize a user based on image data received from the camera; adapt one or more settings of the GUI in response to recognizing the user based on image data received from the camera.

The input mechanism mentioned above may also utilize a voice recognition module and/or a gesture recognition module. This embodiment of the device may also utilize at least a portion of a historical record of device use to preload personalized user settings prior to user recognition through the input mechanism. This device may also communicate with at least one other smart home device in response to recognition of a user based on image data received from the camera. The device may also utilize motion sensor(s), infrared (IR) sensors, etc. in addition to or in place of camera(s) to detect and track the presence of end users.

This embodiment of the device may also include one or more settings including a communications profile. The communications profile may also include an email account, a short message system account, and/or mobile telecommunications account.

A goal of the present invention is to provide additional functionality to mirrors. At present, mirrors reflect images and do little else besides take up space. The present invention enables mirrors to become part of a smart home and capable of displaying a digital clock, weather, messages, web sites and other applications similar to a smartphone or tablet. This additional functionality takes the mirror from being one of the least multifunctional furnishings in a dwelling to one of, if not the most functional.

An advantage of the present system is it enables presentation of smart home and smart phone data in a novel way. Almost every adult in America wakes up each morning, checks their phone, and goes to the bathroom. The present system enables these adults and others to have their smartphone messages, outside temp, shopping list, etc. presented to them in the mirror with little to no user interaction needed.

Another advantage of the present system is that is can record data regarding each user's routine to aid each user throughout their day. For example, if a user sets their smart phone alarm for 7 AM, the system can collect this information and know that a given user will be awaking at 7 AM then most likely entering the bathroom. The system can then pre-load this user's profile and have it instantly load on the smart mirror when the user is detected in the bathroom.

Yet another advantage of the present system is a practical one. The present smart mirror system is optimized to function without the need for tactile user input. Many smart refrigerators, smart TVs, etc. feature touchscreens which enable users to access various applications and information. The use of a touchscreen for a mirror is impractical however and the present system is optimized to work with voice recognition, facial recognition, gesture recognition, etc. to prevent issues surrounding touching a mirror.

Still yet another advantage of the present invention is that it improves the efficiency of mirror usage. In the morning time is precious and time in front of the mirror is “mandatory” and typically quite significant. For many this is the longest single task every morning and it is of great value and convenience to utilize this time to get updates on the news, emails, friends, weather, etc., while taking care of the usual tasks performed in front of the mirror.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an overview of a smart mirror system.

FIG. 2A is a diagram of the components of a smart mirror.

FIG. 2B is a diagram of a smart mirror displaying augmented reality visual elements.

FIG. 2C is a diagram of a smart mirror displaying augmented reality visual elements superimposed upon a user's reflection.

FIG. 3A is a perspective view of a smart mirror's graphical user interface.

FIG. 3B is a front view of a smart mirror in use.

FIG. 4A is a diagram of a smart mirror system communicating with another smart home device.

FIG. 4B is a diagram of a smart mirror system communicating with multiple smart home devices.

FIG. 5A is a flow chat which demonstrates how an end user's routine may be established by the smart mirror system.

FIG. 5B is a flow chat which demonstrates how an end user's routine may be monitored by the smart mirror system.

### DETAILED DESCRIPTION OF THE INVENTION

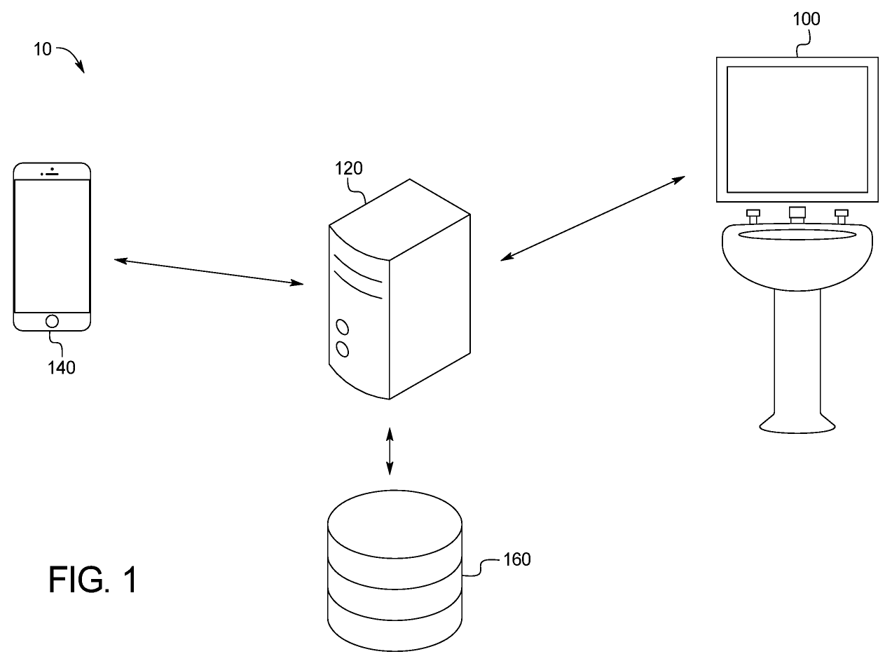

FIG. 1 is an overview of a smart mirror system 10. As shown in FIG. 1, the system 10 may feature a smart mirror 100, centralized server 120, end user device 140, and external data source 160. The smart mirror 100 may communicate with the centralized server 120 via wired or wireless connection with the smart mirror 100 displaying information obtained from the server 120. Communication between the server 120 and end user device(s) 140 and external data source(s) 160 may also be carried out via wired or wireless connection.

In this embodiment, when a user wishes to utilize the smart mirror 100, they first setup a user profile which may also be automatically generated by the smart mirror system 10. The user profile is stored within the centralized server 120 and this profile details information such as the user's preferences, location, preferred applications, and other customization settings. This information is also linked to at least one form of security verification, which can be in the form of voice imprint, gesture, an associated end user device, etc. Once a user's profile is established within the system 10, when a user approaches the smart mirror 100 and verifies themselves, the system 10 will display the user's preferred applications, text messages, etc.

End users may control the smart mirror 10 via their end user device(s) 140. In this example, the end user device 140 is a smart phone, but the smart mirror may also be controlled by tablets, person computers, and other smart home devices. Once configured, the smart mirror system 10 may operate autonomously and update itself based off changes in an end user's usage of the system 10. The system 10 may also be in communication with one or more external data source(s) 160 to provide up to date news, weather, calendar, and social media information amongst other potential sources of data.

As mentioned above, when an end user establishes a profile within the system 10, the system 10 will then continuously update this profile based off user patterns and other behavior through machine learning, artificial intelligence, etc. or manual user setting updates. For example, each person in a household has a routine based off common bed times, wake times, when they must be at school, work, meetings, etc. To make better use of system 10 resources and improve the value a smart mirror 100 offers to each end user, the smart mirror system 10 can automatically learn these timing and usage patterns through artificial intelligence and/or machine learning. Once each user's usage patterns are learned by the system 10 it can carry out many different tasks including loading a user's profile upon the smart mirror 100 so it is instantly available to an end user at a given time during the day.

The system 10 can also, through artificial intelligence and/or machine learning, begin to predict updates to usage patterns, etc. For example, if school is canceled for the day because of snow (or likely to be canceled), this information may be obtained by the system 10 automatically from an external data source 160 (in this case a local news website) and then not load the children's profile, applications, etc. on the smart mirror 100 when they normally would be to save system 10 resources as well as energy and data usage.

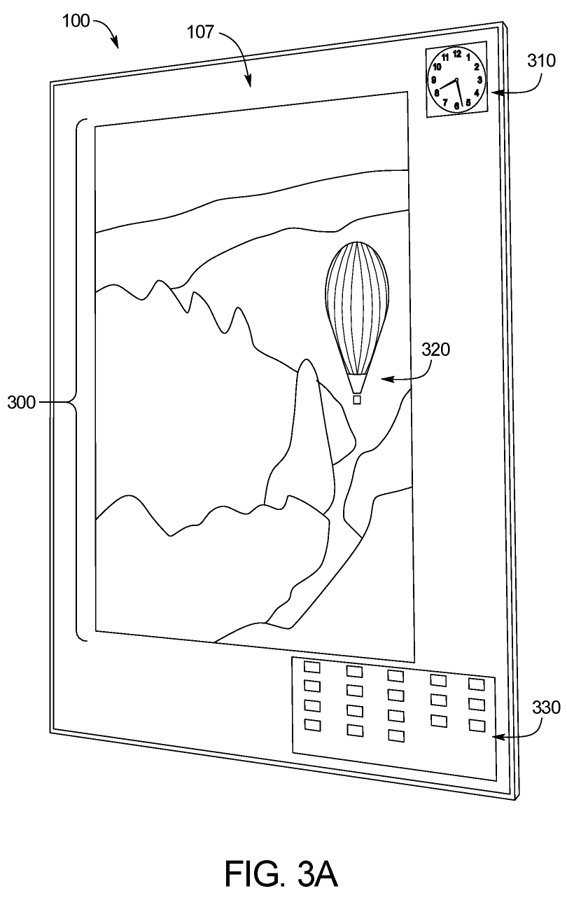

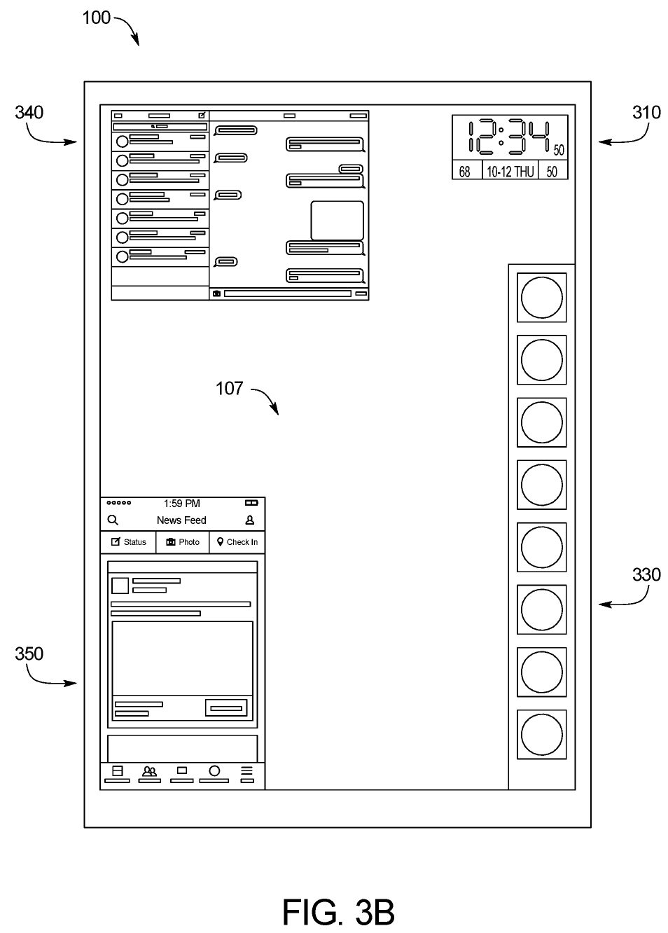

For example, if a family household has a father, mother, son, and daughter, each likely has their own routine. The father, in this example, is a baker who rises very early in the morning to get ready for work. When the father's alarm sounds at 3 AM on his smartphone, the smartphone may signal the smart mirror 100 to load the father's profile. Alternatively, the smart mirror system 10 may already have this information about the father's early arousal time stored within the father's profile. Knowing that the father is awake around 3 AM, the system 10 may then preload all the information the father wants displayed on the smart mirror 100 when he enters the bathroom. All of this information is displayed as part of the smart mirror's 100 graphical user interface 300 (GUI) (see FIG. 3).

Continuing with this example, the father has previously set up his GUI 300 to display his meetings for the day, any unread text messages, todays weather, and top headlines. Most, if not all of this information must be downloaded from external data sources 160 including news databases or websites and the father's email account as well as text messages from his smartphone (end user device 140). All of this information, in this example, is collated by centralized server 160 which is in communication with the smart mirror 100 over the internet. Once the father enters the bathroom and announces his presence, the mirror 100 will verify his voice and display his pre-loaded set of requested information. Logout of the father's profile may be done after a certain amount of time, done upon voice command, or done upon detection of another user in or near the bathroom. Log in/out could also be tied activation of the light switch in a given room, turning on/off of the bathroom faucet, or another operation of a given room's fixtures, appliances, etc.

The text messages, etc. which are communicated to the smart mirror 100 from the father's smartphone (end user device 140) as well as the emails, calendar information, social media updates, etc. which are communicated from an end user device 140 or external data source 160 (e.g., work email server, scheduling database, etc.) may be addressed or altered via the smart mirror 100. For example, once the end user (the father) checks his unread texts and emails, the smart mirror 100 will communicate any response messages but also update the end user's smart phone, email account, etc. to reflect that the messages have been read and/or addressed. This two-way communication between the smart mirror 100 and other system 10 components is important because the ability of the smart mirror to send information back to other devices as well and internal and external servers/data sources enables the end user to improve the efficacy of their day. Previously the time spent looking in the mirror can now (for example) also be used to read emails and update one's calendar, combing two tasks into one.

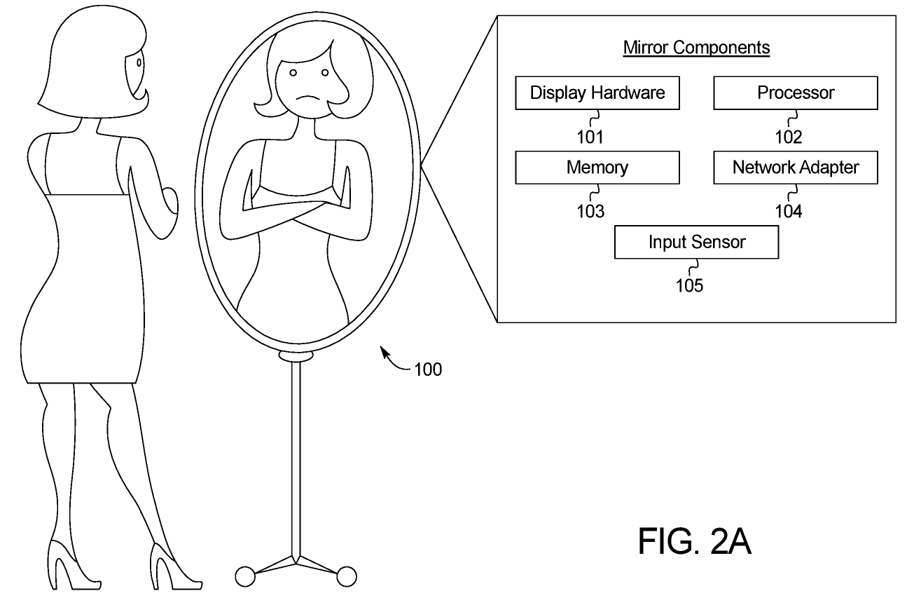

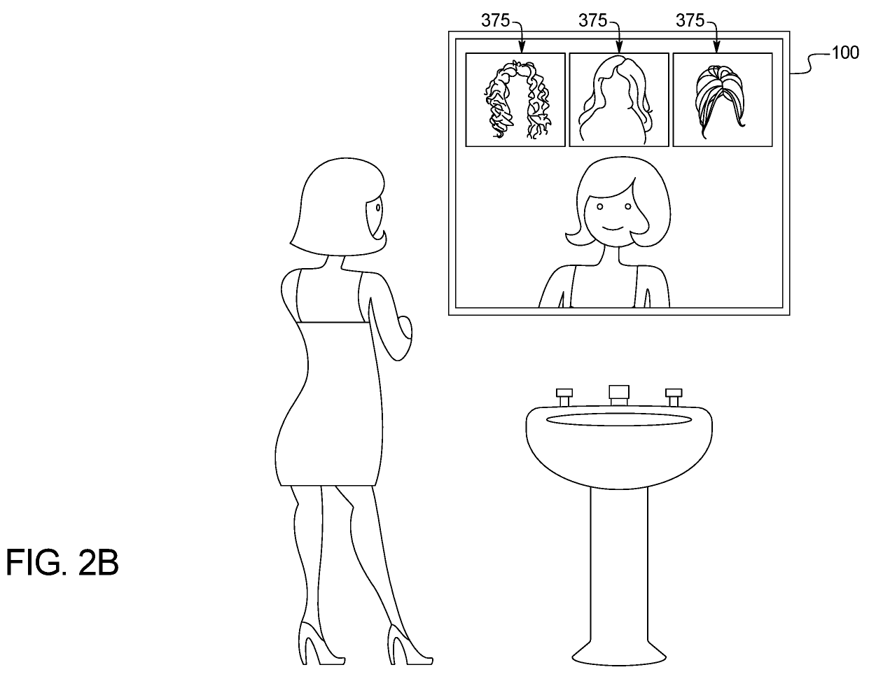

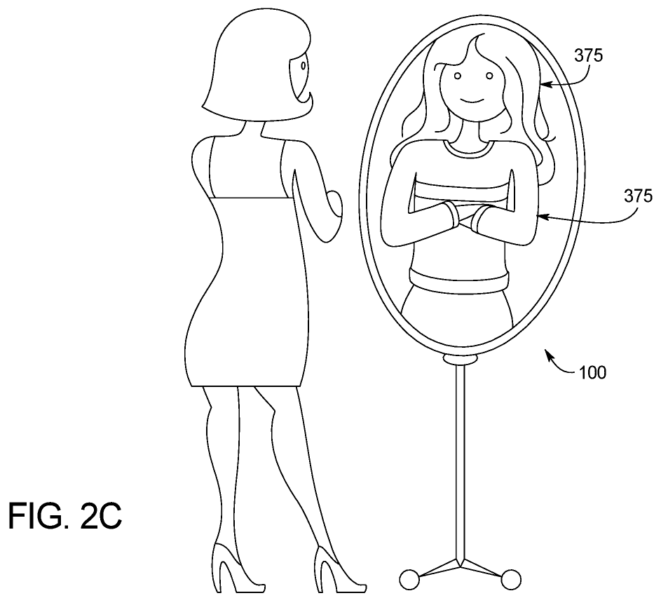

FIG. 2A is a diagram of the components of a smart mirror 100. As shown in FIG. 2A, a smart mirror 100 can be placed in various locations throughout a dwelling and not just the bathroom. In this example, the mirror 100 is located in a bedroom, with the mother from the household example used in FIG. 1 assessing her appearance. The smart mirror system 10 may, in some instances, be configured to control more than one smart mirror 100 within a home. In this example, the mother is getting ready for her day with the smart mirror 100 displaying any information she wishes. Display of such information is enabled by the components of the smart mirror which include the display hardware 101, a processor 102, memory 103, network adapter 104, and input sensor 105.

The display hardware 101 may be any form of mirrored surface which can also display computerized information. The display hardware 101 may be one (or multiple) LCD, LED, or Plasma panels which have a mirrored surface applied to them to enable such functionality. Alternatively, the smart mirror may be a one-way mirror or semi-transparent mirror. Such mirrors are partially reflective and partially transparent and allow a computerized display to sit behind a mirror and be visible only when the display hardware 101 is active.

The display hardware 101 is controlled by the processor 102 which enables the display hardware 101 to present information stored in the memory 103 of the smart mirror 100. The processor also receives information from the centralized server 120 (see FIG. 1) and other sources via the network adapter 104. The network adapter may be a wired or wireless adapter and can include Wi-Fi, Bluetooth, ZigBee, NFC, RFID, etc. as means of communication with other devices.

The input sensor 105 may be one or more sensors which enable an end user to control the smart mirror 100. As mentioned previously, voice sensors may be utilized to access and control the smart mirror 100. Other sensors can include, but are not limited to, cameras, motion sensors, photodetectors, retinal scanners, finger print scanners, etc. It should also be noted that the input sensor may be located on an end user device. For example, in some embodiments of the smart mirror system 10, to log into a given smart mirror's 100 user profile, the end user may need to perform a fingerprint scan on their end user device 140. The end user device 140 will then communicate successful verification of the user's identity to the smart mirror 100, which will then display their predefined set of information upon the mirror 100.

It should be noted it is fully realized that components mentioned here as separate may be integrated into one another with communication directly between end user devices 140 and the smart mirror 100, etc. being capable. Additionally, the smart mirror 100 may also function as a stand-alone device with no connection to other user devices 140 required.

One example of the motivation behind a stand-alone smart mirror 100 could be the integration of a camera as an input sensor 105. Many people would be hesitant to install a camera into the mirror they robe and disrobe in front of Given the large number of scandals involving hacking and theft of compromising photos, for some, a smart mirror would need to be totally disconnected from the internet. Such a stand-alone smart mirror 100 would exist with the network adapter 104 being left out of the construction of the mirror 100.

Such a stand-alone smart mirror 100 would be ideal of aiding end users while dressing or applying makeup. Many people own a large wardrobe and it can be difficult to decide what to wear on a given day. This leads some to take photographs of each of their garments to quickly scroll through them all when deciding what to wear. Such a digital record of a wardrobe could take up a good deal of space on a photo cloud, etc. and is susceptible to hacking. A smart mirror 100 could capture images of an end user in their various clothes (or just the clothes) and enable them to be displayed upon the mirror 100 next to the user's actual reflection. This same functionality could be applied to various types of makeup, accessories, undergarments, and, shoes. Once the smart mirror 100 has built a catalogue of wardrobe items, it can then mix and match them by isolating the images of various clothing pieces and allowing them to be displayed with other captured images of clothing.

Updates to a stand-alone smart mirror 100 may be done via USB drive, SD card, etc. which enable the one-way transfer of data and prevent the need for the smart mirror to be connected to the internet.

Alternatively, given the advances in modern computer security, if an end user feels comfortable with the smart mirror 100 being connected to the internet and still featuring a camera, such an embodiment may enable a further enhanced dressing experience. For example, a style magazine or other service may create an application for the smart mirror 100 which suggests new outfits each day. These outfits may be based off what is already present in an end user's wardrobe (pictures of which are stored by the mirror 100) and may also feature items on-sale from a certain website, etc. In this way, the smart mirror 100 could also be commercialized; with clothing retailers paying to have their goods displayed as part of the dressing application.

Practical solutions to the camera security concerns are also fully envisioned by the present invention. Such solutions can include a physical cover which can be positioned over the camera input sensor 105 internally or externally. The camera or other input sensor 105 (e.g., microphone) cover may be totally disconnected from the smart mirror's 100 other components to prevent hacking and can even function as a totally manual solution.

FIG. 2B is a diagram of a smart mirror 100 displaying augmented reality visual elements 375. As shown in FIG. 2B, a smart mirror's graphical user interface (GUI 300, see FIG. 3A) can display augmented reality visual elements 375 for an end user to select for display upon their reflection (see FIG. 2C), next to their reflection, etc. In this example, the end user is reviewing different hairstyle augmented reality visual elements 375 stored by the smart mirror 100. These different hair styles can be ones actually worn by the end user, with the smart mirror 100 capturing images of them via its camera input sensor 105 or downloaded from the internet from various external data sources 160 such as Pinterest, etc. It should be noted the images displayed by the smart mirror 100 can be images which the end user has no interaction with or ones which are superimposed or otherwise interactive (e.g., augmented reality visual elements 375).

FIG. 2C is a diagram of a smart mirror 100 displaying augmented reality visual elements 375 superimposed on an end user's reflection. As shown in FIG. 2C, the smart mirror 100 may display augmented reality visual elements 375 superimposed over the reflection of an end user. The location of where the end user is standing is detected by one of more of the input sensors 105 and the smart mirror 100 then displays via its graphical user interface (GUI 300, see FIG. 3A) one or more augmented reality elements 375 which give the illusion of the end user wearing the various articles of clothing, etc. This enables an end user to virtually try on an outfit or shop for a new one as well as test out the appearance of new makeup or a different haircut.

Embodiments of the present system 10 are also capable of learning and tracking patterns in users clothing selections. The system 10 can observe, via image recognition or manual user input, what outfits or pieces of clothing are worn regularly by a given end user based off the established wardrobe for that user. Depending on these usage patterns, the system 10 can suggest matching sets of clothing, shoes and accessories for a specific day of the week (e.g., casual Friday). The system 10 could also suggest the end user purchase new items if, for example, an end user wears a particular pair of jeans often. The system 10 can, through its connection with external data source(s) 160, offer a link for the end user to buy the same or similar pair of jeans from various retailers.

FIG. 3A is a perspective view of a smart mirror's 100 graphical user interface 300. As shown in FIG. 3A, when active, the smart mirror 100 will display a GUI 300 which may display various applications and information similar to what is seen on modern smartphones or tablets. The GUI 300 shown features a clock visual element 310, main display visual element 320, and an application menu visual element 330. Each of these visual elements may be altered depending on the programming of a given smart mirror 100, but in this example, the smart mirror 100 has been programed to display a welcome image upon initial activation as the main display visual element 320. When an end user decides they wish to open another application within the GUI 300, this initial welcome image will be replaced by that application within the main display visual element 320. The clock visual element 310, in this example, remains persistently in place so the end user can keep track of time. The smart mirror's 100 reflective surface 107 can also be seen as still visible around the perimeter of the GUI 300 in this example.

An example for the GUI 300 in action can be continued from the household example started in FIG. 1. This time, the son who lives in the household gets up and begins getting ready for school. He stands in front of the smart mirror 100 and activates it via voice control. Once activated, the mirror 100 displays to him his preset GUI 300 which features one of his favorite scenic images as the welcome image on the main display visual element 320. As the son gets ready for the day, he can check what time it is on the clock visual element 310 and then, via voice command or another type of control, trigger the smart mirror 100 to open the Facebook application from the application menu visual element 330. After stating “Mirror, open Facebook” the mirror 100 will display the Facebook application, optimized for use on the smart mirror 100, within the main visual display element 310. The son can continue to open and close other application in this same manner and then log out of the smart mirror 100 when done. When logged out, the mirror may go back to the appearance of a normal mirror or continue to display some information (e.g. the current time), depending on end user settings.

The present system 100 may also display information related to the user's morning routine and if they are running late, etc. For example, if the son's routine was to wake at 8 AM, enter the bathroom at 8:05 AM, and depart the bathroom at 8:20 AM, the mirror 100 could keep track of this usage pattern. If one day the son first accesses the mirror at 8:25 AM, the mirror could remind the son that he is running late, or at least behind his regular schedule.

FIG. 3B is a front view of a smart mirror 100 in use. As shown in FIG. 3B, the smart mirror 100 may feature different display configurations. In this example, the GUI's 300 visual elements are dispersed around the perimeter of the smart mirror 100 with the reflective surface 107 remaining visible during operation. It should be noted the arraignment of where various applications display on the smart mirror 100 can be altered based off end user settings. The clock visual display element 310 in this embodiment features a modern digital appearance with information regarding the time, date, and external/internal temps listed. The application menu visual display element 330 in this example runs vertically up one side of the mirror. The application icons shown on the application menu visual display element 330 may be some, or all of the applications installed on the smart mirror 100. Each of these applications may be launched separately or in unison via voice command, gesture controls, etc.

In this embodiment, the end user (the son from FIG. 3A's discussion) has launched the text messaging application (applications being one type of visual display element) 340 and Facebook application 350 which are displayed in a space efficient manner in two corners of the smart mirror 100. The text messaging application 340 may resemble that of a smartphone or tablet with a list of contacts and associated messages shown. In this example, the son has decided to respond to one of his contacts by stating “Mirror, text Angela and tell her I am running late.” The smart mirror 100 will then, via its input sensor 105 (a voice sensor) trigger the smart mirror system 10 to communicate this message to Angela via a talk-to-type algorithm amongst other system 10 components.

The end user in this example has also opened the Facebook application 350. However, to open this application, the end user utilized gesture recognition enabled by another input sensor 105 (a camera) of the smart mirror 100. The end user gestures towards the portion of the smart mirror 100 featuring the application menu visual display element 330 until the Facebook application's 350 icon is highlighted, then gestures for the mirror 100 to open the application. Which gestures control the mirror can be preset and refined over time as the end user utilizes the system 10.

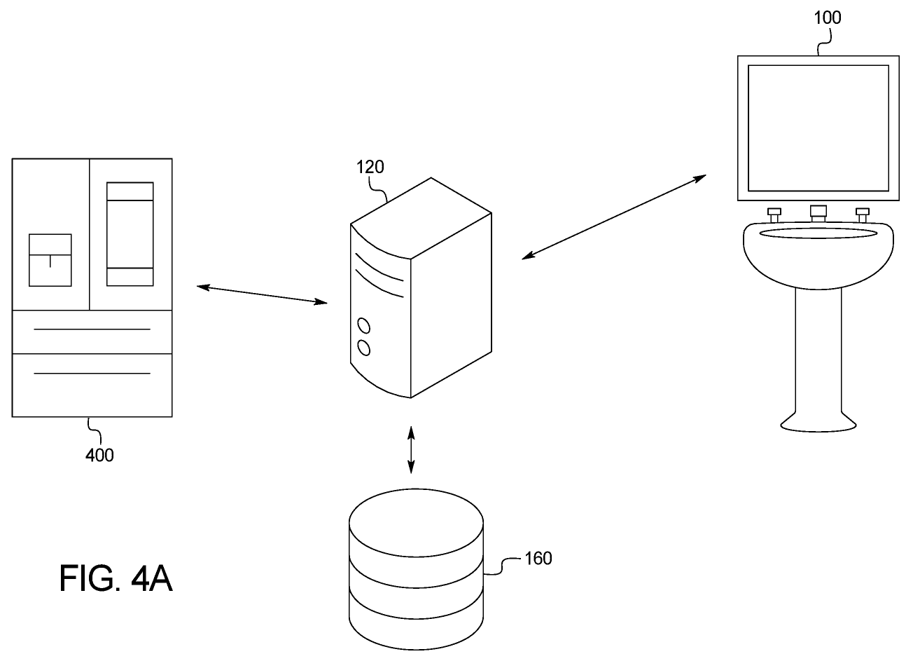

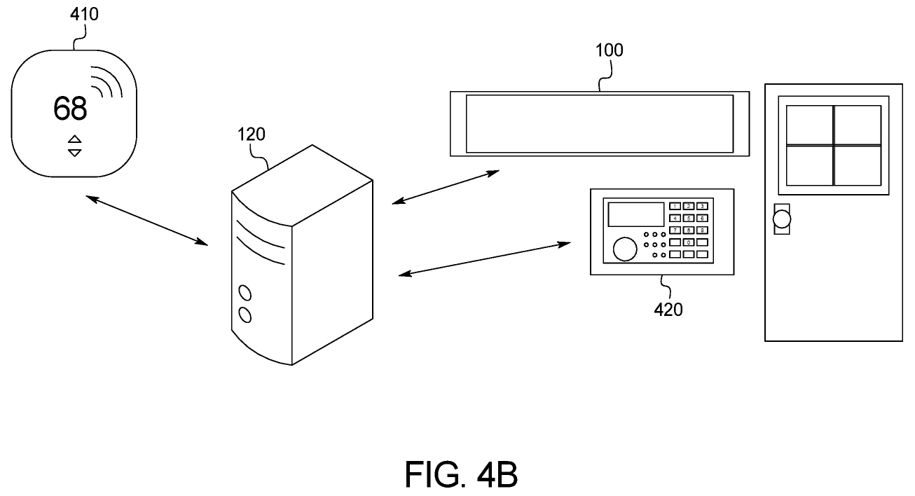

FIG. 4A is a diagram of a smart mirror system 10 communicating with another smart home device. As shown in FIG. 4A, the smart mirror system 10 may communicate with one or more smart home devices such as a smart fridge 400, smart TV, smart thermostat, lights, etc. to offer end users enhanced functionality and smart home controls. In the example shown, a smart fridge is in communication with the smart mirror 100 via the system 10′s centralized server 120. Such communication can be carried out by wired and/or wireless connection and in this embodiment, Wi-Fi is utilized to enable ease of set up and instillation of the smart mirror 100 anywhere within a home (within range of the home's Wi-Fi connection). Information related to weather, traffic, news, social media, etc. may also be uploaded to the system 10 via one or more external data sources 160.

The functionalities enabled by the smart mirror system being able to communicate with, integrate with, and/or control other smart home devices and systems is endless. In the example shown however, one of the most practical uses of the communication between the smart fridge 400 and smart mirror 100 utilizes the routine tracking functionality mentioned in FIG. 3A's description. Again, using the household example started in FIG. 1, this time the daughter of the household is getting ready. She awakens at 7 AM and normally takes an hour to get ready in the bathroom. The smart mirror makes note of this routine's timeline and then, through communication with the smart fridge 400 can continue to remind the daughter (or another end user) of their current adherence to their routine's timeline.

Accordingly, if on another day the daughter awakens at 6:30 AM and leaves the bathroom smart mirror 100 at 7:00 AM, the smart mirror system 10 may communicate a message to the smart fridge which states: “Daughter is running an hour early today, good work!” for display upon the smart fridge's 400 user interface. This is just one example of the functionality possible with the current system 10.

Another example of the present system's 10 integration with other smart home devices could enable the mother of the house, who drives both kids to school, to observe the status of her children's routine. For example, the mother of the son and daughter may be in the kitchen preparing breakfast and lunches for her children. From the smart fridge's 400 display, she can see that her daughter is up early and ahead of her normal routine. She can also then check the status of her son's routine and whether he has started it or not (e.g., if he has gotten up yet). If the son has not yet awakened or accessed the smart mirror 100 at the time he normally does, the system 10 may inform the mother of this information and offer to turn the lights on in his room via smart home controls, remotely turn the smart mirror 100 on, or allow the mother to disable such measures if the son is sick that day, etc.

FIG. 4B is a diagram of a smart mirror system 10 communicating with multiple smart home devices. As shown in FIG. 4, the smart mirror 100 in this example is positioned by the front door. This positioning is particularly useful because it enables the system 10 to track the entrance and exit of persons from a residence. In this example, as an end user departs the home, the smart mirror 100 may send instructions to other smart home devices to save energy, etc. The smart thermostat 410 in this example communicates with the smart mirror 100 to reduce HVAC usage while a home's residents are out. Additionally, the smart security panel 420 is triggered to arm the home's security system when the last resident leaves in the morning.

The smart mirror 100 may also be utilized as part of a home's security system, specifically for the verification of identity. The smart mirror 100 may have integrated into it a retinal scanner or other biometric sensor (e.g., gait analysis sensors) as one or more of its input sensors 105 which enable the mirror 100 to confirm the identity of an individual entering the home and then disable the security system via the security panel 420 automatically. The biometric scanning input sensor(s) 105 hidden within the smart mirror 100 also provide a clandestine and aesthetically pleasing manner to conduct such verifications.

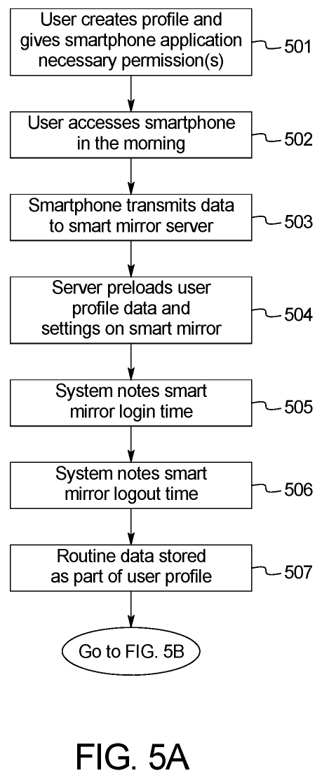

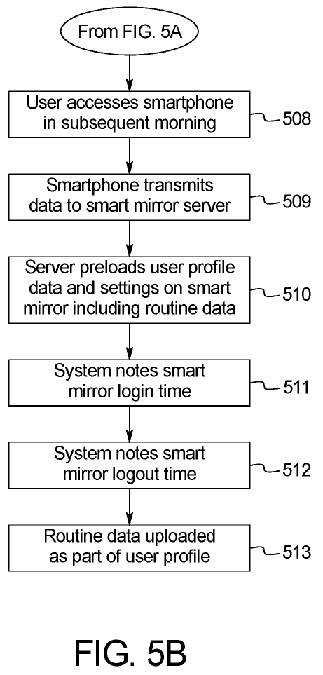

FIG. 5A is a flow chat which demonstrates how an end user's routine may be established by the smart mirror system 10. As shown in FIG. 5A, at a first step 501 an end user creates a user profile which is stored by the smart mirror system 10. The smart mirror system 10 may receive this profile information in any number of ways, but in this example the information is uploaded by an end user from the end user device 140 to the centralized server 120. The end user device 140 may feature a dedicated standalone application for establishing and maintaining profiles and settings of the smart mirror system 10. This application may be granted the ability to monitor basic information about the end user smart phone usage such as alarm times, accelerometer data (so the system 10 can be notified when the end user is awakened in the morning), and when an end user first accesses their smartphone (end user device 140) in the morning. All the above pieces of information as well as others can be transmitted to the smart mirror system 10 to enable it to preload an end users profile on a smart mirror 100 connected to the system 10.

Once an end user has a profile established and enables to system 10 to track their routine, the system will then begin noting when an end user first awakens in the morning (marked by the first smart phone access of a given morning, step 502). Once a user is confirmed to be awake (step 502), the system 10 will then preload this user's profile, data, and GUI 300 customization settings (see FIG. 3) via the smart mirror's 100 processor 102 and memory 103 (step 503). When a user is ready, they may log into the smart mirror 100 via voice command, etc. at which point their customized GUI 300 will appear upon the smart mirror 100. Upon this login, the system 10 will note the time of the smart mirror login (step 505) and logout (step 506) and then store this usage information as part of the given user's profile data (step 507).

FIG. 5B is a flow chat which demonstrates how an end user's routine may be monitored by the smart mirror system 10. After an end user's routine information is initially established by the system 10 (step 507), the system 10 may then begin, on subsequent mornings, to remind a given end user of their adherence to their previously established routine. Monitoring of this routine timeline beings when an end user again first accesses their smartphone (end user device 140) in the morning (step 508). After initial access of their end user device 140, the device 140 will inform the system 10 of the user's accesses (step 509) and the system 10 will then in response preload the user's profile as before, but this time include the routine data (510). Upon this and subsequent smart mirror 100 access, the system 10 will note the user's smart mirror 100 login (step 511) and logout times (step 512) and update the routine data (step 513) if needed.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A device comprising:
a reflective mirror surface including a front face;
a camera oriented to capture image of user located in position in front of the reflective mirror surface;
a processor in communication with the camera to receive image data captured by the camera;
an electronic display in communication with the processor through which the processor provides a GUI visible at the front face of the mirror;
an input mechanism other than a touchscreen input mechanism, the input mechanism providing input data from a user to the processor; and
a memory in communication with the processor, the memory storing a plurality of personalized user settings associated with image data and executable instructions that, when executed by the processor, cause the processor to:
receive image data from the camera;
recognize a user based on image data received from the camera;
adapt one or more settings of the GUI in response to recognizing the user based on image data received from the camera.

2. The device of claim 1, wherein the input mechanism utilizes a voice recognition module.

3. The device of claim 1, wherein the input mechanism utilizes a gesture recognition module.

4. The device of claim 1, where in the device utilizes at least a portion of a historical record of device use to preload personalized user settings prior to user recognition through the input mechanism.

5. The device of claim 1, where in the device communicates with at least one other smart home device in response to recognition of a user based on image data received from the camera.

6. The device of claim 1, wherein one or more settings include a communications profile.

7. The device of claim 6, wherein the communications profile includes an email account, a short message system account, or a mobile telecommunications account.

8. The device of claim 1, wherein a motion sensor is used in place of a camera to confirm the presence of the user.

9. The device of claim 1, wherein an infrared sensor is used in place of a camera to confirm the presence of the user.

10. A method of displaying information upon a reflective mirror surface, the reflective mirror surface including a front face, comprising:
a camera capturing an image of a user located in a position in front of the reflective mirror surface;
a processor communicating with the camera to receive image data captured by the camera;
an electronic display communicating with the processor through which the processor provides a GUI visible at the front face of the mirror;
an input mechanism other than a touchscreen input mechanism providing input data from a user to the processor; and
a memory communicating with the processor, the memory storing a plurality of personalized user settings associated with image data and executable instructions that, when executed by the processor, cause the processor to:
receive image data from the camera;
recognize a user based on image data received from the camera;
adapt one or more settings of the GUI in response to recognizing the user based on image data received from the camera.

11. The method of claim 10, wherein the input mechanism utilizes a voice recognition module.

12. The method of claim 10, wherein the input mechanism utilizes a gesture recognition module.

13. The method of claim 10, where in the device utilizes at least a portion of a historical record of device use to preload personalized user settings prior to user recognition through the input mechanism.

14. The method of claim 10, where in the device communicates with at least one other smart home device in response to recognition of a user based on image data received from the camera.

15. The method of claim 10, wherein one or more settings include a communications profile.

16. The method of claim 10, wherein the communications profile includes an email account, a short message system account, or a mobile telecommunications account.

17. The method of claim 10, wherein a motion sensor is used in place of a camera to confirm the presence of the user.

18. The method of claim 10, wherein an infrared sensor is used in place of a camera to confirm the presence of the user.
